(19) United States
(12) Patent Application Publication
(10) Pub. No.: US 2009/0250560 A1
(43) Pub. Date: Oct. 8, 2009

(54) Utility Tray Module for Power Plant Construction

(76) Inventor: Shui-Fang Chou, Troy, MI (US)

Correspondence Address: SHUI-CHOU CHOU, 5032-12 Hunt Club Road, Wilmington, NC, 28403, US

(21) Appl. No.: 12/419,290

(22) Filed: Apr. 6, 2009

Related U.S. Application Data
(60) Provisional application No. 61/042,783, filed on Apr. 7, 2008.

(51) Int. Cl. F16L 3/00; E04C 2/52; B21K 23/00

(52) U.S. Cl. 248/49; 52/220.1; 29/897.3

(57) ABSTRACT

Utility tray for accommodating cables, pipelines, and other utilities comprises a plurality of tray modules. The tray module has a hanging strip that attaches to the structural component of the concrete, such as welded studs and rebars. Concrete locking groove is provided to interlock the concrete wall, thus rigidity of attachment to the concrete is enhanced. A vertical locking protrusion and a vertical locking groove are provided to position and interlock tray modules vertically. A lateral locking fin and a offset notch are provided to interlock tray modules laterally. Tray modules can be made by extrusion method and roll-formed method. The tray modules are assembled laterally and vertically to form a utility tray of desired length and height. Besides accommodating utilities, the utility tray can serve as the construction mold during concrete pouring.

### CROSS-REFERENCE TO RELATED APPLICATIONS

This application claims the benefit of U.S. Provisional Application Ser. No. 61/042,783 filed on Apr. 7, 2008.

### BACKGROUND OF THE INVENTION

(1) Field of Invention

This invention relates to a utility tray that accommodates cables, light sources, pipelines, ventilation ducts, and other utilities; specially relates to a utility tray that can be integrated and direct locked into the existing structural components of concrete walls, particularly locked into the existing concrete structures of power plant construction.

(2) Description of Related Art

The complexity of utility tray layout within electricity power generation plant commonly demands extensive laboring hours. The seismic qualification of such utility tray system for nuclear power plant also demands extensive engineering resources. Conventionally, the construction of the utility tray system is commonly scheduled after the construction of the building structure, which results in lengthy power plant construction duration. In recent days, many modular construction approaches for the power plan building thick (i.e. 4 ft to 6 ft) reinforce concrete structural components (i.e. modular shear wall, ceiling, floor) have been studies. One of the construction approaches for modular construction of these reinforced concrete structural components is replacing reinforcing rebar by steel plate with welded studs, shown by Toshio Yamashita, et al (U.S. Pat. No. 6,745,533 B2). Not only these reinforcing steel plates replace rebars, but also they can be served as the concrete mold before filling concrete is poured. After concrete structures has been cured, and then follow the layout of the cable tray by mechanically anchoring the utility tray support(s) to concrete structure member. Furthermore, because the safety against fire hazard, nuclear power plant demands layout separation on safety related cable. This cable separation requirement has made the layout of the utility tray become further complex. Additionally, the extra labor on installing added-on fire protection insulation will lengthen the construction time. Accordingly, it is desirable to have devices that can mitigate all abovementioned disadvantages.

### BRIEF SUMMARY OF THE INVENTION

The present invention is drawn to a utility tray for accommodating cables, light sources, pipelines, ventilation ducts, and other utilities. It comprises a plurality of tray modules that can be locked into the existing structural component of concrete and be assembled laterally and vertically to desired length and high. Accordingly, several objects and advantage to the present invention are: (1) to provide a utility tray that can be self anchored to concrete structural component(s); (2) to provide a utility tray which can serves as concrete mold used for concrete pouring; (3) to provide a utility tray that is easily assembled and quickly install into complex layout, thus saves laboring hours and expense; (4) to provide a utility tray that matches high standard of seismic qualification; (5) to provide a utility tray that can facilitate the installation of fire protection insulation. Still further objects and advantages of present invention will become apparent from a consideration of the drawings and ensuing description.

### BRIEF DESCRIPTION OF SEVERAL VIEWS OF THE DRAWINGS

FIG. 1 is a side view of one embodiment of the invention.

FIG. 2 is a side view of another embodiment.

FIG. 3 is a side view of the other embodiment.

FIG. 4 is a perspective view of one embodiment of tray module.

FIG. 5 is a perspective view of another embodiment of tray module.

FIG. 6 is an optional embodiment of the present invention.

### REFERENCE NUMERALS IN DRAWINGS

10 tray module
12 hanging strip
14 opening/closing panel
20 concrete locking groove
22 vertical locking groove
24 vertical locking groove
26 inter modular looking fin
28 offset notch
30 concrete
31 exterior wall reinforcing steel plate with welded studs
32 welded studs
34 steel stirrup rebar
36 horizontal reinforcing steel rebar
38 vertical reinforcing steel rebar
40 anchoring strip
50 utility holder
100 cable
110 spacer
120 fireproofing insulating panel
130 tie rod
140 faceplate
150 light panel module
160 pre-embedded bolt anchor for construction bracing
170 shoring column and face plate
180 construction bracing
200 hanging attachment (i.e. channel or bracket)

### DETAILED DESCRIPTION OF THE INVENTION

The present invention is drawn to a utility tray for accommodating cables, light sources, pipelines, ventilation ducts, and other utilities. It comprises a plurality of tray modules that can be locked into the existing structural component of concrete and be assembled laterally and vertically to desired length and high.

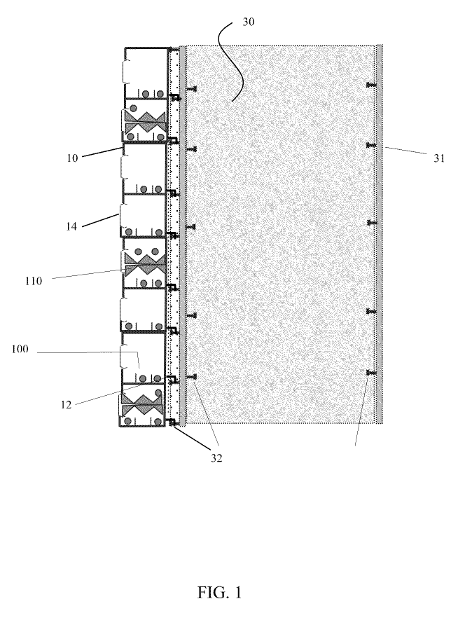

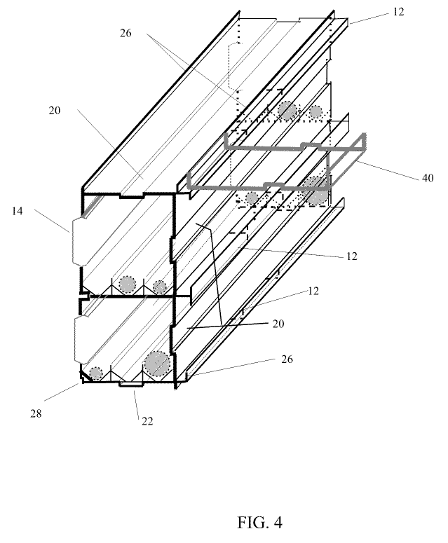

FIG. 1 is a side view of one embodiment of the present invention. A utility tray comprises a plurality of tray modules 10 (detailed see FIGS. 4 & 5). Each tray module 10 has a hanging strip 12 that firmly hangs to the welded studs 32 or welded channel segment(s) on steel-reinforcing plates when these steel plates 31 are used as a mold for concrete pouring. FIG. 1 shows eight tray modules 10 that assemble vertically and stack together. Certainly, these tray modules 10 can be assembled vertically to any desired height and/or laterally to any desired length. Besides welded studs 32, the hanging strips 12 can attach to the welded channels or fastener on the steel reinforcing plates. Additionally, optional fasteners can be used to fasten individual utility tray 10 to provide additional rigidity against overturning, sliding as well as vertical vibrations.

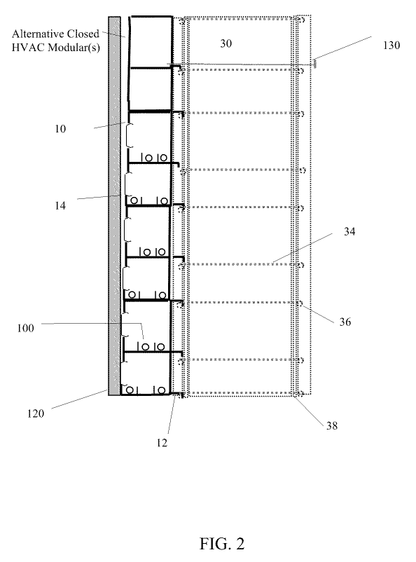

FIG. 2 illustrates another embodiment of the present invention. Conventional reinforced concrete used embedded steel reinforcing rebar (FIG. 2), instead of embedded steel-reinforcing plate with welded studs, welded channels and fasteners shown in FIG. 1. Utility tray can serve as mold plates for concrete pouring, besides accommodating utilities. In construction the concrete wall, the rebars will be put into position by tiring with the wires. After all rebars are in position, hanging strips 12 of the tray module 10 can hang on and attach to the rebars. To accommodate vertical reinforcing steel rebar(s) 38, hangs strip 12 may be notched. To accommodate a horizontal rebar 36 near the tip of the hanging strip 12, the tip of hanging strip 12 will hang across horizontal rebar 36.

The tray modules are assembled laterally and vertically to a desired height and length, and thus form the utility tray having wall-like configuration that can serve as a mold plate for pouring concrete. After concrete is cured, hanging strip 12 will then be fully embedded in the concrete 30 The separated adjustable hanging strips 12 may be used when installing of the utility tray, the purpose of the adjustable hanging strips 12 is to adjust its position in order to insert into the space between vertical rebars 38 and horizontal rebars 36 so that hanging strips 12 have deep embedded length.

Also illustrated in FIG. 2, an optional fire insulation wall panel(s) 120 can be installed after the layout of the cable to protect cable from fire hazard. These fire insulation wall panels 120 can be divided into multiple sections, which directly mounted to the interior faces of the cable tray or cable tray opening-closing panel 14. During the safety inspection of the cable 100, individual fire insulation panel 120 can be dismounted to allow visual inspection or maintenance of the cables 100. Optional tie rod 130 may be used to tie the tray module 10 across two face of the concrete wall. These tie rods 130 will be either mechanical fastened to the backside of the tray module, to the hole on the hanging strip or directly to construction bracing column(s). A seal ring may be need to plug the hole clearance to limit overflow of concrete during pouring of concrete structural component(s).

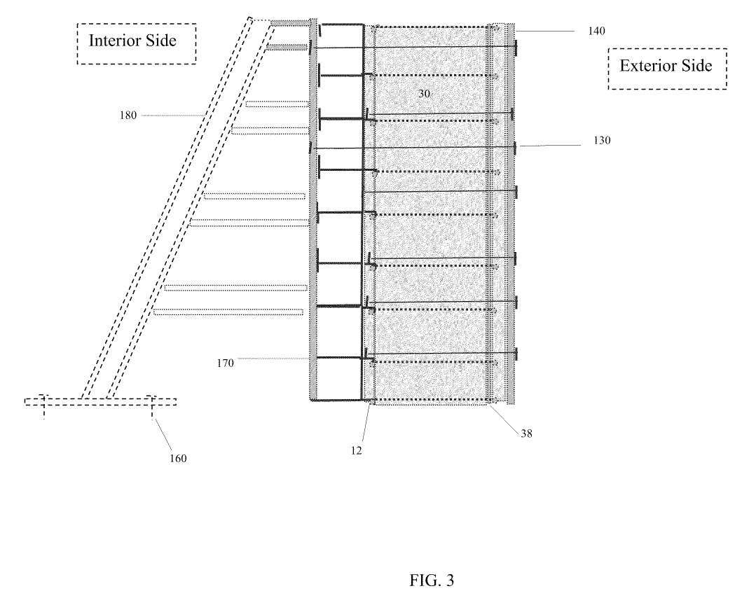

Referring to FIG. 3, tray modules assemble into utility tray. The utility tray serves as the interior mold of the concrete wall, while a metal plate serves as the exterior mold. Individual tie rod 130 ties tray module 10 and exterior metal plate mold 140 to provide stability to the exterior mold. These tie rods 130 can be mechanical fastened to the backside of the tray module 10, to the hole on hanging strip 12 or directly to construction bracing column(s).

FIG. 3 also shows interior construction shoring assembly (shoring braces 180 and shoring faceplate/columns 170) to illustrate the shoring brace(s) during construction. A construction bracing 180 mounted on concrete slab provides the stability to the utility tray mold and exterior steel plate mold by resisting the overturning moment as well as lateral force. After the construction, the preset embedded bolt anchor 180 may be torch cut to top of slab level. Construction bracing has a multiple shoring columns or shoring plates which bracing by framing of the bracing. Shoring columns or plates will support surfaces of the cable tray modules through surface contacts or mechanical devices. In order to further facilitate the placement of the tie rods and pouring the concrete, the stage stacking up of the modules can be adopted (i.e. the continue stacking up of modules to increase wall height during the concrete pouring).

A tray module 10 is illustrated in FIG. 4. It comprises a hanging strip 12, a concrete locking groove 20, a vertical locking protrusion 22, a vertical locking groove 24, inter modular locking fin(s) 26 and offset notch (s) 28.

The hanging strip 12 is configured (e.g., L- or T-shape) to hang to an integral component of the concrete structure (e.g., vertical reinforcing steel rebars 38 in FIG. 2 or welded studs 32 in FIG. 1), and thus anchors the tray model 10 to the concrete wall.

Concrete locking groove 20 provides tray module 10 further support. It is known that during pouring, the mixture flow of the concrete will fill the cavity of channel (after the vibrating the concrete mixture during pouring). Concrete locking groove 20 will act like a “Shear Key” to support the utility tray, the gravity forces will be resisted by the cured concrete shear strength, and the outboard pulling tension will be resisted by the bounding between the concrete and cable tray.

Vertical locking protrusion 12 and vertical locking groove 14 are configured for assembling tray modules 10 vertically to a desired height. Inter modular locking fin(s) 26 and offset notch 28 will enhance interlocking of module together and increase stability of the utility tray.

If desired, the left panel has an opening/closing panel 14 that will be installed after utilities are laid out. Optional anchoring strip 40 can mechanically ( i.e. fastener, clips) attached to the hanging strip 12 of neighboring utility module 10 to increase the overall rigidity of the tray module assembly, Together with the rigidity from hanging strip 12 and interlocking vertical locking protrusion 22, these cable tray will be structurally secured.

Tray module 10 can be made either of metal (e.g., aluminum, magnesium, or lead) or of plastic (e.g., carbon fiber reinforced plastic). Many exiting arts can be adopted to make the tray model. One preferred method for manufacturing the tray model is the extrusion process. FIG. 4 also illustrates a modular unit 10 manufacturing through the extrusion process of either metal or plastic ). The extruded unit contains two open cells formed by extruded walls. The walls may have geometry features to enhance either its rigidity (i.e. ribs, channels) or its interlocking (i.e. Inter Modular Locking (concave) channel(s), Inter Modular Locking fin(s)). Back wall(s) of the modular has geometry feature(s) (e.g., T or L shape hanging strip 12 (s) to serve as the anchor through it embedment (e.g., concrete locking channel) in concrete or hanging to steel rebar(s), or welded stud(s). A plurality of optional anchor strips 40 (e.g., L shape anchor 40 shown in FIG. 4) which are mechanically attached (i.e. fastened or geometric clipped) to concrete hanging strip(s) 12. These anchor strips 40 will further enhance the anchorage rigidity of cable tray assembly. The cable(s) 100 will be placed after the construction of the cable tray and after semi-cure of the concrete. The opening/closing panel 14 will be installed after layout of the cables 100.

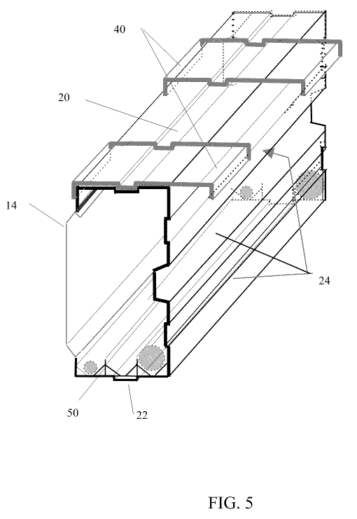

Another preferred method for making tray module is rolled formed process. FIG. 5 illustrates a tray module 10 that is made of steel sheet through the rolled formed process. The extruded unit is a single open cell formed by roll-forming of steel sheet to form the geometric features, such as vertical Locking Groove(s) 20, vertical locking protrusion 22 and Concrete Locking Groove(s) 24. Between the tray module 10, there are a plurality of hanging strip 12 ( e.g., Concrete Locking Strips shown in FIG. 5). These Concrete Locking Strips 40 are inserted between tray modules and have the geometry compatible to the Inter Modular Locking Groove. The Concrete Locking Strips can be either mechanical (i.e. weld, fastener) to the tray unit as an integrated modular or can be a separate unit which can be placed during the stacking of the modules. The floating position of the Concrete Locking Strip(s) will enable itself to be self adjusted when inserted into the space among concrete reinforcing rebar.

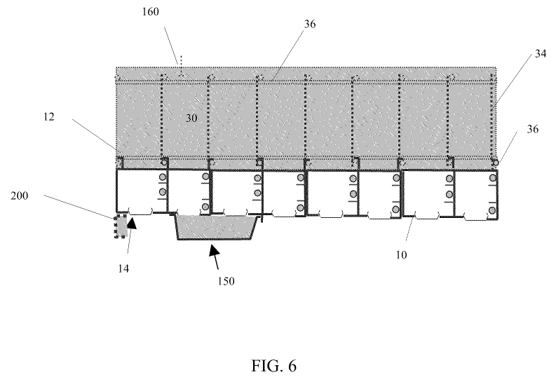

Utility tray can also serves as a bottom mold of the slab or roof. FIG. 6 illustrates a lateral stacking up tray modules, which serves a bottom mold of the slab or roof. Tray modules can hook on embedded lateral or stirrup steel reinforcing rebar(s) of reinforced concrete by hanging strips 12 (L or T shape). Hanging strips 12 may have a plurality of post machining cut out notches to accommodate vertical reinforcing steel rebar(s). An optional light module can be mounted to these tray modules after the layout of the utilities, such as cables, pipelines, ventilation ducts. Optional hanging attachment 200 (i.e. bracket or channel) can be post mechanically attached to these tray module(s) to serve as hanger to hang additional devices such as the mechanical piping, fire sprinkles or aforementioned optional light module. Vertical construction braces will support these inter-locked cable tray molds during the pouring and curing of the concrete.

The abovementioned preferred embodiments and the best mode of carrying out the invention are intended to illustrate but not to limit the present invention. It will be apparent to one skilled in the art that various substitutions and modifications may be made to the invention disclosed herein without departing form the scope and the spirit of the invention. For example, tray modules can be assembled in a different orientation. This assembly allows the utility tray to rotate 90 degree so that the utilities, such as cables or pipelines, inside the utility tray can be installed vertically, instead of laterally. Also some casing of the tray module can be replaced by back plate. These and many other modifications and variations are considered to be within the scope of present invention. Accordingly, the scope of the invention should be determined by the claims and their legal equivalents, rather than preferred embodiments and the best mode given.

What is claimed is:

1. An utility tray for accommodating a utility pipeline onto a concrete structure, comprising a plurality of tray modules, the tray module having:
a casing for accommodating the utility pipeline; and
a hanging device firmly connected to the casing at a predetermined position and sandwiched between the casing and the concrete wall, the hanging device be configured for mating a structural means of the concrete structure so that the casing attaches to the concrete structure and links consecutively of a predetermined length and height with respect to the concrete structure, whereby the utility tray is formed.

2. The utility tray of claim 1, wherein the utility tray serves as a construction mold during pouring and curing concrete of the concrete structure, whereby the handing device is embedded in the concrete structure.

3. The utility tray of claim 1, wherein the structural means of the concrete wall is a welded stud on a steel-reinforcing plate of the concrete structure.

4. The utility tray of claim 1, wherein the structural means of the concrete wall is a welded segment on a steel-reinforcing plate of the concrete structure.

5. The utility tray of claim 1, wherein the structural means of the concrete wall is a rebar of the concrete structure.

6. The utility tray of claim 1, wherein the tray module is manufactured by extrusion method.

7. The utility tray of claim 1, wherein the tray module is manufactured by roll-forming method.

8. The utility tray of claim 1, wherein the casing further comprises a concrete locking groove on the outer surface for filling concrete during pouring, whereby the concrete structure, after being cured, locks the utility tray at a predetermined position.

9. The utility tray of claim 1, wherein the casing further comprises a vertical locking groove on the top and a vertical locking protrusion configured for mating the vertical looking groove on the bottom, so that one tray module stacks easily onto another tray module to a desired height, whereby a vertical interlocking joint is formed.

10. The utility tray of claim 1, wherein the casing further comprises an inter-modular locking fins on one side of the casing and an offset on the other side, whereby interlocking joint is formed.

11. The utility tray of claim 1, wherein the casing further comprises an opening/closing panel on opposing side of the concrete structure for accessing the utility pipeline.

12. The utility tray of claim 1, wherein the casing further comprises a cable-laying floor within the casing, the cable-laying floor is contoured for accommodating the utility pipeline individually.

13. The utility tray of claim 1, wherein the hanging device is T-shaped.

14. The utility tray of claim 1, wherein the handing device is L-shaped.

15. The utility tray of claim 1, further comprising a seal ring for plugging hole clearance to limit overflow of concrete pouring.
